(19) United States
(12) Patent Application Publication
(10) Pub. No.: US 2002/0180609 A1
(43) Pub. Date: Dec. 5, 2002

(54) Metal/metal oxide sensor apparatus and methods regarding same

(76) Inventors: Kang Ding, Blaine, MN (US); W.E. Seyfried JR., St. Paul, MN (US); Zhong Zhang, St. Paul, MN (US)

Correspondence Address: MUETING, RAASCH & GEBHARDT, P.A., P.O. BOX 581415, MINNEAPOLIS, MN, 55458, US

(21) Appl. No.: 10/150,734

(22) Filed: May 17, 2002

Related U.S. Application Data
(60) Provisional application No. 60/292,212, filed on May 21, 2001.
(60) Provisional application No. 60/291,979, filed on May 18, 2001.

(51) Int. Cl. G08B 21/00; G08B 17/10

(52) U.S. Cl. 340/633; 340/620

(57) ABSTRACT

Various pH sensor apparatus, and methods of providing such apparatus, include using a hydrogen ion (H⁺) sensitive element formed of a corrosion-resistant metal, such as titanium or zirconium. The pH sensitive element makes use of a discontinuous metal oxide layer, e.g., titanium dioxide, formed on a surface of the metal hydrogen ion (H⁺) sensitive element (e.g., titanium wire core element). Preferably, the discontinuous metal oxide layer is formed by thermal treatment in the presence of an oxygen containing media. The pH sensor apparatus may be used with any of a range of standard reference electrodes for providing the pH measurement. Further, a pH sensor apparatus can be used as a reference electrode with a hydrogen sensing electrode, e.g., a fine gold wire, for measuring dissolved hydrogen (H₂) concentrations.

### CROSS-REFERENCE TO RELATED APPLICATIONS

This application claims the benefit of U.S. Provisional Application Serial No. 60/291,979 and Serial No. 60/292,212, both entitled “pH SENSOR AND SYSTEMS/METHODS REGARDING SAME,” filed May 18, 2001 and May 21, 2001, respectively, wherein such documents are incorporated herein by reference.

### STATEMENT OF GOVERNMENT RIGHTS

The present invention was made with support from the National Science Foundation under OCE Grant No. 93001195, EAR Grant No. 9614427, and OCE Grant No. 9633132. The government may have certain rights in this invention.

### TECHNICAL FIELD OF THE INVENTION

The present invention relates generally to sensors. More particularly, the present invention pertains to electrochemical metal/metal oxide sensors for various applications, such as for sensing pH and/or hydrogen concentration.

### BACKGROUND OF THE INVENTION

Measurement of chemical parameters, e.g., pH, gas concentrations, etc., are important in many different applications, e.g., control systems, aqueous systems of geothermal-related power generation, nuclear facilities, etc. For example, in the process world, pH is an important parameter to be measured and controlled. The pH of a solution indicates the acidic or basic (i.e., alkaline) characteristics of the solution. The formal mathematical definition of pH is the negative logarithm of hydrogen ion activity. In most cases, hydrogen ion activity can be approximated by the hydrogen ion concentration, and the formula becomes pH=−log10[H⁺]. On the pH scale, which varies from 0 to 14, a very acidic solution has a low pH value, a very basic solution has a high pH value, and a neutral solution has a pH of approximately 7.

A pH measurement apparatus is typically made up of several components. Such components include a pH sensor, which includes a measuring electrode, a reference electrode, and in many cases also a temperature sensor. Such components provide measurement signals which are generally operated upon by various devices so as to provide a desired parameter measurement, e.g., a signal conditioning device may be used to provide amplified sensor signals to a processing apparatus for analysis.

In an exemplary operational state, when immersed in a solution, the measuring electrode of the pH sensor is generally an electrode sensitive to hydrogen ions, and which develops a potential (i.e., voltage) directly related to the hydrogen ion concentration of the solution. The reference electrode provides a stable potential against which the measuring electrode can be compared, i.e., the reference electrode potential does not change with the changing of hydrogen ion concentration.

The output of the measuring electrode may change with temperature (e.g., even though the process remains at a constant pH). As such, the temperature sensor is typically used to correct for this change in output. Such temperature compensation is known and is usually performed in an analyzer which receives the sensed signals.

The sensed measurement signal and reference signal are generally amplified by a preamplifier prior to application to a processing apparatus for analysis. For example, the preamplifier may take the high impedance pH electrode signal and change it into a low impedance signal which the analyzer can accept. The preamplifier also strengthens and stabilizes the signal, making it less susceptible to electrical noise.

The processing apparatus is operable to provide a desired parameter measurement output based on the sensed signals. Generally, a value indicative of the pH of the solution is displayed, although data representative of the pH may be used for automatic control in one or more various feedback loops of a control system without display. The calculation and display of pH is usually performed using an analyzer having a human machine interface for calibrating the sensor and configuring outputs and alarms, if pH control is being performed.

As acidity is among one of the more important chemical parameters in aqueous solutions, effective pH measurements need to be performed. Various types of pH sensors exist for use in providing such measurement.

Conventionally, for example, a glass electrode has been used to perform such pH measurement. However, glass electrodes are generally only applicable to temperatures below 100° C. In addition, they are generally expensive, fragile, and difficult to miniaturize, which limits potential applications for such electrodes. Recent new developments have replaced glass electrodes with more durable electrodes, for example, solid-state sensors, as indicated further below.

Further, for example, YSZ ceramic pH sensors have also been used for pH measurement and have been emphasized recently as an effective manner of measuring pH in a hydrothermal fluid, especially in hot spring vents at mid-ocean ridges. For example, exemplary YSZ sensors are described in Ding, K. and Seyfried, W. E. Jr., “In-situ measurement of dissolved H₂ in aqueous fluid at elevated temperatures and pressures,” Geochimica et Cosmochimica Acta, Vol 59, pp. 4769-4773 (1995) and Hara N. and Macdonald, D. D., “Development of dissolved hydrogen sensors based on yttria-stabilized zirconia solid electrolyte with noble metal electrodes,” J. Electrochem. Soc., Vol.144, pp. 4152-4157 (1997). Although the YSZ pH sensor responds well to pH at elevated temperatures and pressures, it appears to have relatively limited stability at low temperature applications (e.g., less than 200° C.). Also, the sensor's fragile nature makes applications under high temperature and pressure conditions challenging with potential for mechanical and thermal shock during applications of the sensor.

In addition to glass and YSZ sensors for measuring hydrogen ion concentration, other alternative H₂ measurement apparatus in aqueous fluid at elevated temperatures and pressures have been provided in the literature. For example, Chou and Eugster, as described in Chou I. M. and Eugster H. P., “A sensor for hydrogen fugacities at elevated P and T and applications,” (Abstr.), Eos; Trans. Amer. Geophys. Union, Vol. 57, p. 340, (1976), developed the Ag—AgCl—H₂O hydrogen sensor, which primarily depends on H₂ permeability through a metallic Pt or Ag—Pd membrane. In their design, H₂ fugacity is indirectly obtained after the experiment by measuring HCI concentrations of the quenched solution in the sensing capsule where the fugacity of Cl₂ is fixed. This is not a direct measurement technique.

Gunter et al., in Gunter W. D., et al., “The shaw bomb, an ideal hydrogen sensor,” Contrib. Mineral. Petrol., Vol. 70, pp. 23-27 (1979), describes the coupling of a small-volume pressure transducer to a metallic membrane permeable to H₂ for measurement of H₂ pressure in hydrothermal experiments. Although this technique is a more direct method for measuring H₂, it has seen limited use due to problems which affect its sensitivity and resolution as described in Gunter, et al., “Hydrogen: Metal membranes,” In Hydrothermal Experimental Techniques (ed. G. C. Ulmer and H. L. Barnes), Chap. 4, pp. 100-120 (1987).

Another in-situ method for H₂ measurement in high temperature aqueous systems is described in Macdonald D. D., et al., “Continuous in situ method for the measurement of dissolved hydrogen in high-temperature aqueous systems,” I & E. C Fundamentals, Vol. 20, pp. 290-297 (1981). This technique makes use of the H₂-dependent resistivity of palladium. The response of this electrode to H₂ was demonstrated for dissolved H₂ at concentrations up to 0.72 mM in 0.1 M boric acid, and at temperatures as high as 275° C.

Palladium/metal-oxide-semiconductor (Pd-MOS) devices have also been reported as a hydrogen sensor for use with high temperature aqueous solutions in Lundstrom, I., “Hydrogen sensitive MOS-structures, Part I: principles and applications,” Sensors Actuators Vol. 1, pp. 423-426 (1981) and in Fomenko et al., “The influence of technological factors on the hydrogen sensitivity of MOSFET sensors,” Sensors Actuators, Vol.10, pp. 7-10 (1992). Like other sensors which involve platinoid metals, such devices suffer from irreversible degradation when exposed to hydrogen sulfide or other sulfide bearing solutions.

Fuel cell hydrogen sensors have been used for monitoring dissolved H₂ in the cooling water of nuclear and fossil fuel power reactors and in transform cooling oil as described in Jonas et al., “Evaluation and applications of a new dissolved hydrogen analyzer,” 64^{th} Ann. Water Conf., Pittsburgh, Pa. (1985). These sensors are based on the platinum-catalyzed oxidation of H₂ coupled with reduction of O₂. A gas-permeable membrane isolates the fuel cell from the sample. Because the cell consumes H₂ faster than it diffuses through the membrane, the cell current is also related to the membrane thickness. However, the minimum practical membrane thickness is determined by the maximum hydrostatic pressure in the cell.

Further, pH sensors relating to titanium oxide include the TiO₂ semiconductor pH sensor reported in Hara N. and Sugimoto K., “A nb-doped TiO₂ semiconductor pH sensor for use in high-temperature aqueous solutions,” J. Electrochem. Soc., Vol.137, pp. 2517-2523 (1990). As described therein, pH measurement was successfully conducted in distilled water from room temperature up to 250° C. In this design, a Nb-doped TiO₂ single crystal ((001) face) was used as a pH-sensitive electrode. The pH response of this sensor is based on the pH-dependent change in the flatband potential, which can be obtained by measuring the Mott-Schottky plot on the semiconductor electrode in a solution. However, the cost of the single TiO₂ (rutile) crystal may limit practical applications of this sensor. In addition, measurement using such semiconductor sensors functions entirely different than when using electrochemical sensors.

In addition, in Ding, K. and Seyfried, W. E. Jr., “Gold as a hydrogen sensing electrode for in-situ measurement of dissolved H2 in supercritical fluid,” J. Sol. Chem, Vol. 25, pp. 419-431 (1996), the use of gold in hydrogen sensing was described.

### SUMMARY OF THE INVENTION

A method for use in providing an electrochemical pH sensing apparatus according to the present invention includes providing an electrically conductive electrode element, wherein at least a surface of the conductive electrode element is formed of titanium (Ti) (e.g., a titanium wire). At least a portion of the surface of the conductive electrode element is oxidized resulting in the formation of a discontinuous titanium oxide (TiOₓ) layer. The oxidation process includes thermally treating the surface of the conductive electrode element in the presence of at least one oxygen containing media.

In various embodiments of the method, the thermal treatment may be performed at a temperature in the range of about 300 degrees centigrade to about 880 degrees centigrade, the thermal treatment may be performed in the presence of at least one liquid oxygen containing media (e.g., a liquid alkali element carbonate or peroxide such as Na₂CO₃, Li₂CO₃, and Na₂O₃), and/or the thermal treatment may be conducted for a time period less than about 2 hours.

In another embodiment of the method, the discontinuous titanium oxide (TiOₓ) layer is formed such that less than 10 percent of the surface of the conductive electrode element is exposed.

Another method for use in providing an electrochemical pH sensing apparatus according to the present invention includes providing an electrically conductive elongated wire element comprising a surface extending from a first end to a second distal end thereof, wherein at least the surface of the conductive elongated wire element includes a metal (M) (e.g., titanium or zirconium). A discontinuous metal oxide (MₓO_{y}) layer is formed on at least a portion of the surface proximate the second distal end of the conductive elongated wire element. Further, an insulating layer is provided on at least a portion of the conductive elongated wire element resulting in an insulated portion of the conductive elongated wire element and a sensing portion at the second distal end of the conductive elongated wire element. The sensing portion includes exposed metal through openings in the discontinuous metal oxide layer. The method further includes providing a conductive support housing about at least a portion of the insulated portion.

In one embodiment of the method, the discontinuous metal oxide (MₓO_{y}) layer is formed by electrochemical plating the surface of the conductive elongated wire element with the metal oxide. Further, the discontinuous metal oxide (MₓO_{y}) can be formed by thermal treatment of the surface of the conductive elongated wire element in the presence of at least one oxygen containing media, preferably a liquid oxygen containing media.

An electrochemical pH sensing apparatus according to the present invention includes an electrically conductive wire core extending between a first end and a second end along an axis, wherein at least a surface of the wire core includes titanium (Ti). A discontinuous titanium oxide (TiOₓ) layer (e.g., a discontinuous titanium dioxide layer) is provided on at least a portion of the surface of the wire core. An insulating layer is formed relative to the discontinuous titanium oxide layer formed on at least a portion of the wire core so as to provide a sensing portion at the second end of the wire core. The sensing portion includes exposed titanium through openings in the discontinuous titanium oxide layer. A conductive support housing that is electrically isolated from at least the wire core by the insulating layer is also provided.

Another electrochemical pH sensing apparatus includes an electrically conductive elongated wire core extending between a first end and a second end along an axis thereof, wherein at least a surface of the wire core includes a metal (M) (e.g., titanium or zirconium). A discontinuous metal oxide (MₓO_{y}) layer is provided on at least a portion of the surface proximate the second end of the wire core. An insulating layer provided on at least a portion of the discontinuous metal oxide layer results in an insulated portion of the wire core and also a sensing portion at the second end of the wire core. The sensing portion includes exposed metal through openings in the discontinuous metal oxide layer. A conductive support housing is provided about at least a portion of the insulated portion.

In at least one embodiment, the discontinuous metal oxide layer, where present, has a thickness of less than 3 micrometers.

Another method is provided for use in providing an electrochemical hydrogen (H₂) sensing apparatus. The method includes providing an electrically conductive elongated wire element with a surface extending from a first end to a second end thereof. At least the surface of the conductive elongated wire element is formed of a metal (M) (e.g., zirconium or titanium). A discontinuous metal oxide (MₓO_{y}) layer is formed on at least a portion of the surface proximate the second end of the conductive elongated wire element. At least a portion of the electrically conductive elongated wire element proximate the second end having the discontinuous metal oxide layer formed thereon is used to provide a reference sensing portion. A conductive layer is provided adjacent to the conductive elongated wire element from the first end to the second end thereof but isolated from the conductive elongate wire element by a first insulating layer. The conductive layer includes a conductive material (e.g., gold) proximate at least the second end to provide a hydrogen sensing portion. A second insulating layer is provided over at least the conductive layer such that the reference sensing portion and the hydrogen sensing portion at the second end are exposed. Further, a conductive support housing is provided about at least a portion of the second insulating layer.

In one or more embodiments of the method, the discontinuous metal oxide (MₓO_{y}) layer is formed by electrochemical plating the surface of the conductive elongated wire element, whereas in other embodiments, the discontinuous metal oxide (MₓO_{y}) layer is formed by thermally treating the surface of the conductive elongated wire element in the presence of at least one oxygen containing media (e.g., a liquid oxygen containing media such as a liquefied alkali element carbonate or peroxide).

In another method of providing an electrochemical hydrogen (H₂) sensing apparatus, the method includes providing an elongated electrode assembly. The elongated electrode assembly is attained by providing a first conductive portion extending from a first end of the elongated electrode assembly to a second end of the elongated electrode assembly, wherein the first conductive portion includes a metal core (e.g., titanium) having a discontinuous metal oxide layer formed on at least a portion of a surface of the metal core. Further, a second conductive portion extending from the first end of the elongated electrode assembly to the second end of the elongated electrode assembly is provided, wherein the second conductive portion includes a conductive material (e.g., gold) for use in sensing hydrogen (H₂). Yet further, an isolation material is provided that extends from the first end of the elongated electrode assembly to the second end of the elongated electrode assembly and which electrically isolates the first conductive portion from the second conductive portion. An insulating material is provided over the elongated electrode assembly resulting in an exposed sensing portion at the second end of the elongated electrode assembly. The exposed sensing portion includes exposed metal through openings of the discontinuous metal oxide layer of the first conductive portion and exposed conductive material of the second conductive portion. A conductive support housing is provided about at least a portion of the insulating material.

In one embodiment of the method, the first conductive portion includes a wire extending along an axis therethrough and a concentric discontinuous metal oxide layer formed on a radial surface of the wire along the axis. Further, the second conductive portion includes a concentric layer of conductive material formed radially relative to the axis and separated from the discontinuous metal oxide layer by the isolation material.

In another embodiment, the first conductive portion and second conductive portion are adjacent to each other but separated by at least the isolation material.

An electrochemical hydrogen (H₂) sensing apparatus according to the present invention is also provided. The apparatus includes an electrically conductive elongated wire core element extending between a first and second end of the apparatus along an axis thereof, wherein at least a surface of the wire core element includes a metal (M) (e.g., titanium or zirconium). A discontinuous metal oxide (MₓO_{y}) layer is formed on at least a portion of the surface of the wire core element proximate the second end. Further, the apparatus includes a conductive layer extending along the axis, wherein the conductive layer includes a conductive material (e.g., gold, palladium) for use in sensing hydrogen. A first insulating layer is located to electrically isolate the conductive layer from the conductive elongated wire core element. Further, the apparatus includes a second insulating layer formed over at least a portion of the conductive layer resulting in a sensing portion at the second end of the apparatus. The sensing portion includes at least a portion of the conductive wire core element having the discontinuous metal oxide layer formed thereon and exposed conductive material. A conductive support housing is also provided about at least a portion of the second insulating layer.

In yet another electrochemical hydrogen (H₂) sensing apparatus according to the present invention, the apparatus includes an elongated electrode assembly. The elongated electrode assembly includes a first conductive portion extending from a first end of the elongated electrode assembly to a second end of the elongated electrode assembly, wherein the first conductive portion includes a metal core (e.g., titanium) with a discontinuous metal oxide layer formed on at least a portion of a surface of the metal core. The assembly further includes a second conductive portion extending from the first end of the elongated electrode assembly to the second end of the elongated electrode assembly, wherein the second conductive portion includes a conductive material (e.g., gold) for use in sensing hydrogen. Yet further, the assembly includes an isolation material extending from the first end of the elongated electrode assembly to the second end of the elongated electrode assembly electrically isolating the first conductive portion from the second conductive portion. An insulating material is formed over the elongated electrode assembly resulting in a sensing portion at the first end of the elongated electrode assembly. The sensing portion includes exposed metal through openings in the discontinuous metal oxide layer of the first conductive portion and exposed conductive material of the second conductive portion. A conductive support housing is provided about at least a portion of the insulating material.

### BRIEF DESCRIPTION OF THE DRAWINGS

FIG. 1 is a block diagram of a pH sensing system using a pH sensor apparatus according to the present invention.

FIG. 2 is a block diagram of a hydrogen concentration sensing system using one or more sensing electrodes according to the present invention.

FIG. 3A is a cross-sectional illustration of one embodiment of a pH sensor apparatus according to the present invention.

FIG. 3B is an illustrative embodiment of a sensing head portion of the pH sensor apparatus of FIG. 3A.

FIG. 3C is an illustrative embodiment for use in describing the discontinuous metal oxide layer of the sensing head portion of FIG. 3B.

FIG. 4A is a cross-sectional illustration of one embodiment of a hydrogen sensing electrode according to the present invention.

FIG. 4B is an illustrative embodiment of a gold foil sensing element for use with the hydrogen sensing electrode of FIG. 4A.

FIG. 5 is a cross-sectional illustration of one illustrative embodiment of a hydrogen concentration sensing apparatus according to the present invention.

FIGS. 6A and 6B are illustrative embodiments of alternative sensing head configurations for the hydrogen concentration sensing apparatus shown generally in FIG. 5.

### DETAILED DESCRIPTION OF THE EMBODIMENTS

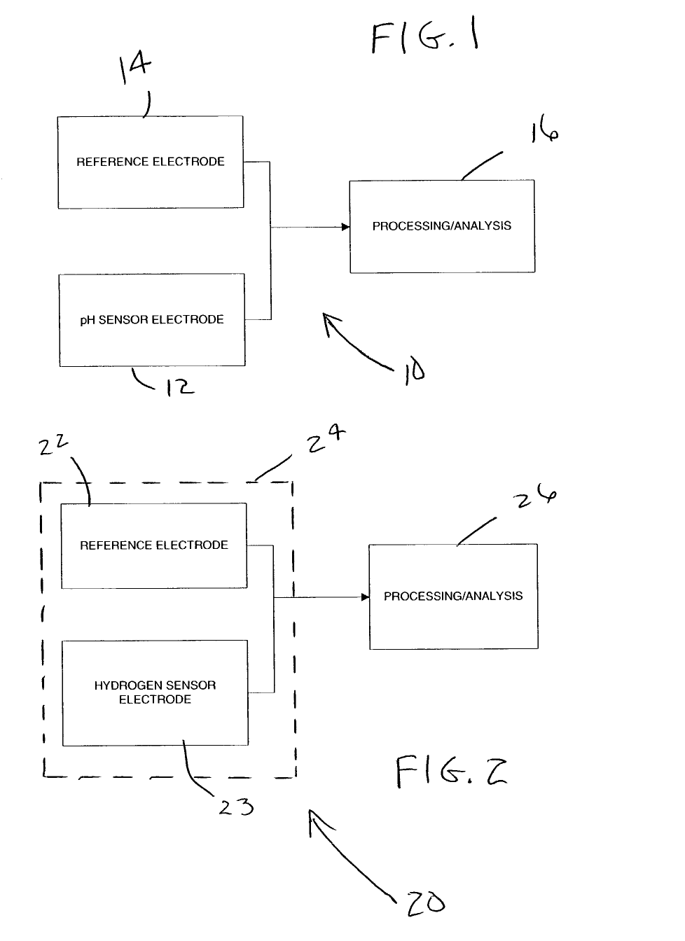

The present invention shall be described with reference to FIGS. 1-5. Generally, according to at least one embodiment of the present invention, the present invention illustrates a small-scale pH sensor apparatus (e.g., pH sensing electrode) that is operable in various applications, e.g., provide measurements in aqueous fluids for various applications. However, although the sensing electrodes described here are preferably sized to meet small scale application requirements, the present invention is not limited to any particular size limitations.

Preferably, the sensors according to the present invention have broad effective temperature and pressure operating ranges. For example, preferably, the sensing apparatus described herein are capable of providing effective measurements in a temperature operating range from room temperature (e.g., 25° C.) to about 425° C. Further, preferably, such sensing apparatus are capable of providing effective measurements in a pressure operating range up to 500 bars (i.e., approximately 500 atmospheres). Likewise, preferably, the sensing apparatus are formed of materials (e.g., titanium, titanium dioxide, gold, etc.) that do not degrade when exposed to sulfide bearing fluids. Effective measurements as defined herein for measuring pH are measurements that are characterized by stability and reversibility.

Generally, the pH sensor apparatus includes a hydrogen ion (H⁺) sensitive element formed of a corrosion-resistant metal, such as titanium or zirconium. The pH sensitive element makes use of a discontinuous metal oxide surface layer, e.g., titanium dioxide, on a surface of the metal hydrogen ion (H⁺) sensitive element (e.g., titanium wire core element) which facilitates pH sensing effects and enhances signal-to-noise ratio. In other words, the hydrogen ion (H⁺) sensitive element is a metal/metal oxide element wherein the metal oxide provided on the surface of the metal is discontinuous to allow hydrogen ions to contact the metal layer upon which the surface oxide layer is formed. The pH sensor apparatus according to the present invention may be used with any of a range of standard reference electrodes for providing the pH measurement.

The surface oxide layer is preferably formed by using heat together with chemical agents, which assist with formation of a surface oxidation product. For example, as described further below, alkali element carbonates or peroxides, preferably in liquid form, may be used for this purpose. However, other surface oxide formation processes may be used such as electrochemical plating methods.

In addition to the direct measurement of pH using the pH sensor apparatus (and an associated reference electrode) according to the present invention, generally in another embodiment, a metal/metal oxide electrode can be used with a hydrogen sensing electrode, e.g., a fine gold wire, for measuring dissolved hydrogen (H₂) concentrations. For example, such a hydrogen (H₂) sensor apparatus may use the metal/metal oxide pH sensor apparatus as a reference electrode in measurement of hydrogen (H₂) concentrations such as hydrothermal fluid. Such hydrogen (H₂) concentrations can be effectively measured in the same temperature and pressure operating ranges as described above with reference to the pH sensing apparatus. Effective measurements as defined herein for measuring hydrogen (H₂) concentration are measurements that are characterized by stability and reversibility.

At least in one embodiment, a gold wire is used as the hydrogen sensing electrode, e.g., the surface of the gold is not pretreated in any manner for use in such a hydrogen (H₂) sensor apparatus. However, in one or more embodiments of the hydrogen (H₂) sensor apparatus, a lower limit to the temperature at which measurements can be made does exist. The lower temperature limit would appear to be about 125° C. However, such a lower limit to the temperature at which measurements can be made is more than compensated by the specificity, stability, and unparalleled corrosion resistance of various embodiments of the hydrogen (H₂) sensor apparatus as described further herein.

The sensing apparatus described herein may be used in a variety of applications. For example, a considerable number of applications for in-situ chemical sensing has arisen in many high technology and industrial fields. Such applications and markets can be found in various areas, including the power industry.

In the power industry, the efficient operation of water-cooled electrical energy generating systems (e.g., nuclear and fossil based systems) requires the continuous monitoring of dissolved H₂ in heat transport media of aqueous fluids at temperatures and pressures as high as 500° C. and 200 bars (approximately 200 atmospheres), respectively. Such control is necessary to suppress corrosion and reduce the transport of corrosive products throughout the system. This latter phenomenon can lead to the fouling of heat transfer surfaces, and in the case of nuclear generating systems, to a dispersion of active nuclides such as ⁶⁰Co into out-of-core components. The dissolved H₂ concentrations in the primary circuits of a pressurized water reactor (PWR) can be as high as 7.6 ppm, while those in the secondary coolant circuit of a PWR, and the coolant circuit of a BWR (boiling water reactor), are usually less than 1 ppm. Thus, a H₂ sensor apparatus, according to the present invention, is very suitable for these applications. Generally, such a sensor apparatus may well be used for safety control in any industrial process which involves water coolant with high temperature heated metal surface.

In addition, other applications include use of the sensing apparatus in the material industry where hydrothermal synthesis of new chemical compounds for superconductor, chemical, and electronics industries (e.g., where temperatures rise up to 374° C. and pressure is at the saturation line) often depend on redox constraint and dissolved H₂ concentrations. For example, the efficacy of pre-cleaning, etching, thermal oxidation and deposition steps in the manufacturing of semi-conductors can be sensitive functions of redox and pH. Availability of sensors with tolerance to corrosive chemical agents and temperature variability would facilitate greatly a number of design, manufacturing and quality assurance processes fundamental to this industry.

Yet further, in recent years, great progress has been made in destruction of hazardous wastes in supercritical water (e.g., where temperatures used may be as high as 500° C. and pressures may rise to 450 bars). It may indeed be possible to convert hazardous wastes such as PCB's into innocuous compounds by using supercritical water as an oxidation medium. As such, in-situ sensors, such as those according to the present invention, may be used in such processes, since they allow direct characterization of reactions at elevated temperatures and pressures.

Environmental protection applications may also make use of the sensors. For example, nuclear and chemical waste disposal requires measurement and monitoring of hydrogen under many extreme operating conditions. For instance, monitoring possible build-up of potentially flammable or explosive H₂ is always essential to keep safe guard on an underground nuclear waste storage tank.

The applications are numerous as described above for the various embodiments of pH sensor apparatus and hydrogen (H₂) concentration sensor apparatus described herein. Such broad applications in industrial processes involving aqueous systems at high temperature and pressure include, but are clearly not limited to: geothermal related power generation; other power industries where high-temperature processes involving aqueous fluids are required, such as nuclear and supercritical facilities; supercritical waste treatment systems; and chemical engineering industry using hydrothermal methods. Yet further, other applications may include medical applications including physiology and medical research due to the advantages of small size, high electrical conductivity, and bio-friendly nature of the sensors described herein.

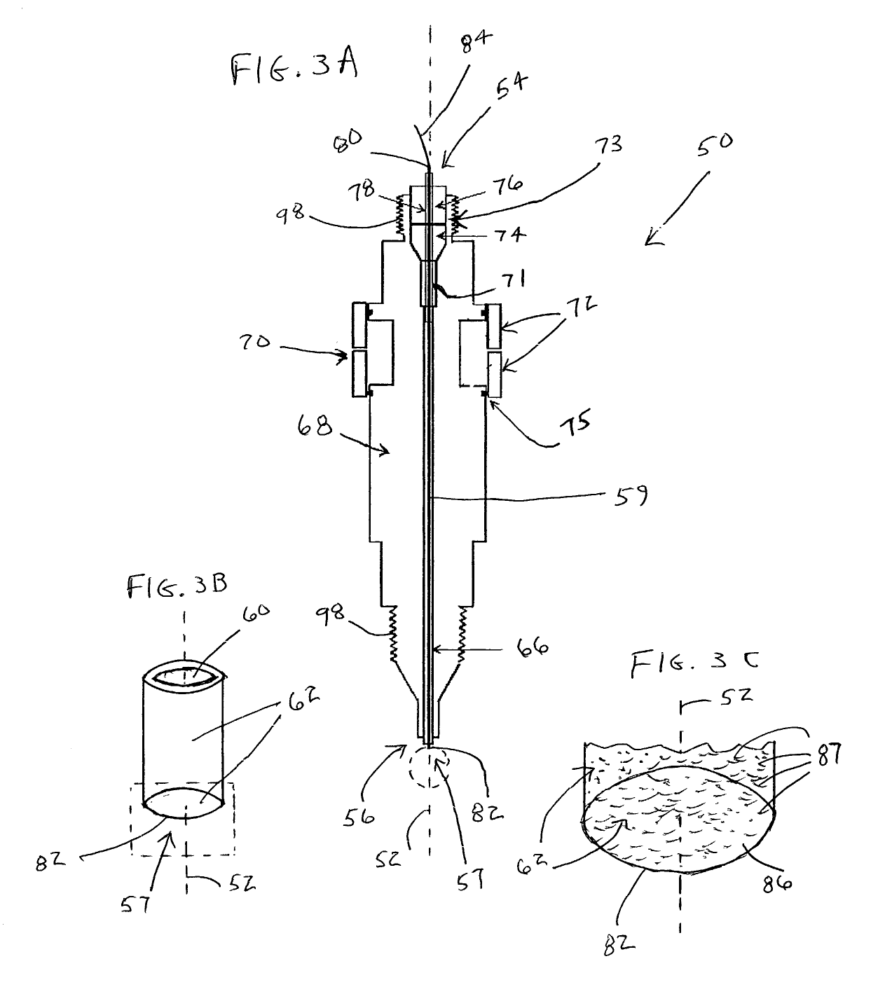

FIG. 1 shows a block diagram of one illustrative pH sensing system 10 according to the present invention. The pH sensing system 10 may be employed in any one of a number of different applications for sensing pH as described above. The pH sensing system 10 includes a pH sensor apparatus (e.g., pH sensor electrode) 12 such as that described with reference to FIGS. 3A-3C, a reference electrode 14, and processing/analysis circuitry 16, e.g., a processor, logic circuitry, signal conditioning circuitry, associated software, associated memory, etc.

Generally, when the reference electrode 14 and pH sensor electrode 12 are immersed in a solution, the potential of the reference electrode 14 does not change with the changing hydrogen ion (H⁺) concentration. The measuring electrode or pH sensor electrode 12, which is sensitive to the hydrogen ion (H⁺), develops a potential (i.e., voltage) directly related to the hydrogen ion (H⁺) concentration of the solution. The reference electrode provides the stable potential against which the potential of the pH sensor electrode 12 can be compared.

The reference electrode 14 may be any conventional reference electrode. For example, such reference electrodes utilized in the past for measuring pH typically include Ag/AgCl or Hg/HgCl₂.

The processing/analysis circuitry 16 may include, for example, a preamplifier to amplify the signals from the electrodes (e.g., electrodes 12, 14) in its operation as a signal conditioning device. Further, for example, the processing/analysis circuitry 16 may include an analog to digital converter for providing digitized data representative of the electrode sensed signal for later processing, or any other measurement-type circuits for comparing voltage or signals from the electrodes 12, 14 to provide a pH measurement. The present invention is not limited to any particular hardware or software configuration. However, such hardware and software is preferably functional to provide a pH parameter to a user based on the sensor signals provided using the electrodes described herein.

The pH sensor electrode 12 of FIG. 1 may take one of various different configurations. Preferably, however, the pH sensor electrode 12 includes one or more features as described with reference to the pH sensor apparatus 50 shown in FIG. 3A.

The pH sensor apparatus 50 preferably extends along axis 52 from a first proximal end 54 (e.g., where one or more leads extend to be coupled to external devices such as processing/analysis circuitry 16) to a second distal end 56. A sensing head 57 having a hydrogen ion (H⁺) sensitive metal at least partially exposed (e.g., for contact with a fluid to be measured) is located at the second distal end 56.

The pH sensor apparatus 50 includes an electrode element 59. The electrode element 59 is provided as best shown in the perspective view of FIG. 3B and FIG. 3C. The electrode element 59 includes a wire core 60 that lies along axis 52 and extends between a first end 80 and a second distal end 82.

Preferably, the wire core 60 is a titanium wire having a wire gauge in the range of about 10 to about 32. However, the present invention is not limited to any particular gauge of titanium wire, e.g., smaller and larger gauge wires may be used. For example, a smaller diameter wire may be used in circumstances where strength is not a substantial factor. Further, one skilled in the art will recognize that the wire as used herein may be of any cross-sectional shape (e.g., square cross-section, elliptical cross-section, polygonal cross-section, etc.); such cross-section taken orthogonal to axis 52.

Further, the present invention may also be implemented in one or more embodiments with the discontinuous oxide layer, as further described below, being formed on any metal (i.e., hydrogen ion (H⁺) responsive metal) electrode structure including, for example a simple planar surface. In other words, one or more of the embodiments described herein are not limited to the use of an elongated element (e.g., wire). Further, one will recognize that the sensor need not be configured along a linear axis but could be of any shape (e.g., curvilinear configuration, etc.), for example, depending upon the particular application.

The electrode element 59 further includes a surface oxide layer 62 formed on at least a portion of the wire core 60 at the second distal end 82. Preferably, the surface oxide layer is provided on the entire wire core 60, e.g., on the outer radial surface thereof.

Preferably, the surface oxide layer 62 is a discontinuous surface oxide layer as illustrated in FIG. 3C. FIG. 3C illustrates the second distal end 82 of the electrode element 60. The surface oxide layer 62 includes metal oxide material 86 provided on the wire core 60 but in a discontinuous manner allowing regions of the metal core 60 to be exposed to hydrogen ions when the sensor apparatus is immersed in fluid. As shown in FIG. 3C, the discontinuous oxide layer 62 includes Is metal core exposure openings 87 of, preferably, suitable size to allow hydrogen ions (H⁺) to pass and contact the metal core 60.

Preferably, the metal oxide material at regions where it is present, is less than about 3 micrometers (i.e., 30,000 Å); more preferably, less than 10,000 Å. Further, generally, the discontinuous surface oxide layer has random discontinuity, e.g., no real pattern to the discontinuity or regions of exposed metal core. For example, the discontinuity of the layer may be in the form of random cracks in the metal oxide layer.

Yet further, the discontinuous metal oxide layer is formed on at least a portion of the surface of the wire core 60 such that less than 10 percent of the metal surface of the wire core 60 (i.e., the surface area of the wire core 60 over which the discontinuous metal oxide layer is formed) is exposed.

Preferably, the surface oxide layer 62 is a discontinuous titanium oxide (TiOₓ) layer formed on the titanium wire core 60. More preferably, the surface oxide layer is formed of titanium dioxide (TiO₂).

Various methods may be used to form the surface oxide layer 62 on the wire core 60. For example, various chemical vapor deposition processes, sputtering processes, or any other physical and/or chemical deposition processes may be used to form the preferred discontinuous titanium dioxide surface layer 62 on the preferred titanium wire core 60. Further, for example, electrochemical plating methods may be used to form the preferred titanium dioxide layer 62 on the preferred titanium wire core 60.

However, preferably, according to the present invention, the surface oxide layer 62 is formed using thermal treatment together with an oxygen-containing media (i.e., agent such a liquid oxidizing agent) that assists in formation of a surface oxidation product. Although any oxygen-containing media may be used, preferably, the oxygen-containing media includes a liquefied oxygen-containing media (e.g., a liquid media that can be used to bath the surface of the metal wires immersed therein). Further, preferably, alkali element carbonates or peroxides are used in the thermal treatment process. Such carbonates and peroxides may include, but are clearly not limited to, alkali element carbonates such as Na₂CO₃ and Li₂CO₃, and peroxides such as Na₂O₂. Generally, such carbonates and peroxides are in the liquid phase at the temperatures used for the thermal treatment (e.g., oxidation process).

Preferably, the thermal treatment of a titanium wire core 60 for forming the surface oxide layer 62 thereon is performed at elevated temperatures in the range of about 300° C. to about 880° C. The temperature used may depend, for example, on the temperature required for liquefying the oxygen-containing media. Yet further, an optimum heating time for the thermal treatment depends upon the actual elevated temperature and various other factors of the process. However, preferably, for example, the thermal treatment is performed for a time period less than 2 hours at ambient pressure. Further, preferably, the time period is greater than about 0.5 hours, although with use of higher temperatures and dependent on the type of oxygen-containing media, the time period may even be less than 0.5 hours.

Preferably, the electrode element 60 includes a discontinuous titanium dioxide surface layer on the surface of a fine gauge titanium wire. Preferably, the titanium dioxide layer is formed with use of Na₂O₂ or Na₂CO₃ as a heated liquid media in the range of 500° C. to 880° C. yielding a desirable oxidized titanium layer on a coexisting titanium wire. The thermal treatment or heating time is preferably about a 0.5 hour time period after the system attains the desired temperature. In such a manner, a thin discontinuous layer of titanium dioxide is formed that coexists with, but yet allows the native titanium metal of the wire core 60 to be exposed; thus, forming a pH sensing pair.

The pH sensing pair (i.e., metal/metal oxide pair) can be illustrated by the following reaction:

TiO₂+4H⁺+4e⁻ [symbol] Ti°+2H₂O

The Nernst equation for this reaction can be described by:

$$Δ {E}_{Ti} ( V ) = {E}_{T , P}^{o} - \frac{2.303 R T}{4 F} log [ \frac{{a}_{w}^{2}}{{a}_{H +}^{4}} ]$$

where ΔE_{Ti}(V) is the measured potential; E_{T,P}° is the standard potential, and a_{w} is the activity of water. All of these parameters can be obtained from thermodynamic data at a given T-P condition. R and F are the ideal gas constant and Faraday constant, respectively. By rearranging the Nernst equation, the measured voltage as a function of fluid pH is obtained:

$$Δ {E}_{Ti / TiO2} ( V ) = {E}_{T , P}^{o} - \frac{2.303 \cdot R \cdot T}{F} p {H}_{T , P} - \frac{2.303 \cdot R \cdot T}{2 F} log ( {a}_{w} )$$

Using the above, the potentials measured by the sensor apparatus described herein can be used to determine a pH measurement.

Considering the strong corrosion resistance of titanium metal and titanium dioxide in acidic, Cl, and sulfide-bearing fluids, along with its mechanical strength, the titanium-based pH electrode greatly enhances the ability to measure and monitor the pH of acidic and corrosive fluids from a variety of industrial and natural environments.

Other pH measurement apparatus conventionally available do not have all of such capabilities. For example, a YSZ ceramic pH sensor and a metal/metal oxide pH electrode such as iridium, palladium, tungsten, and ruthenium dioxide electrodes are typically not suitable for various reasons including those listed in the background section hereof. For example, YSZ sensors may not be reliable at temperatures below 200° C., owing to their high input impedance. Further, the fragile nature of the YSZ ceramic pH sensor makes applications under high temperature and pressure conditions difficult. As for other metal-metal oxide pH electrodes, their reactivity with sulfide bearing fluids, such as hydrogen sulfide may limit their use. Titanium-based pH sensors, however, do not suffer from such limitations and provide a cost effective sensor relative to other conventional sensors.

The process described herein for forming the discontinuous surface oxide layer 62 on the wire core 60 is effective for providing a sieve-like structure that allows hydrogen ions (H⁺) to pass therethrough and be effectively sensed. With such a process, and due to the mechanical strength of titanium, an electrode with small cross-section area less than or equal to 0.020 inches (0.5 mm) (outer diameter, O.D.) can be constructed. With use of an electrode element 59, including the titanium wire core 60 and a surface titanium oxide layer 62 thereon, an effective response of the sensor can be provided even at low temperatures. However, such an electrode responds well even at 300° C. and higher temperatures.

With further reference to the pH sensor apparatus 50 of FIG. 3A, an insulating material 66 is provided about the electrode element 59 along the axis 52 of the pH sensor apparatus 50. For example, the insulating material 66 may include a ceramic epoxy coating along a length of the titanium dioxide layer 62 formed on the titanium wire core 60 of the titanium/titanium oxide electrode element 59. The insulating material 66 extends to within a particular distance from the second distal end 82 of the electrode element 59, leaving a sensing portion or sensor head 57 exposed at the second distal end 82 of the electrode element 59. The sensing head 57 provides exposed titanium dioxide surface area which includes openings 87 for allowing the hydrogen ions of a fluid being monitored to pass therethrough so as to contact the underlying exposed titanium wire core 60.

To provide an application-ready pH sensor apparatus 50, preferably, a conductive support housing 68 is formed over at least a portion of the electrically insulating material 66 to provide an electrode for use in taking potential measurements from the apparatus 50 between the electrode element 59 and the conductive support housing 68. Preferably, the conductive support housing 68 extends over a substantial portion of the insulating material 66 from the first end 54 of the pH sensor apparatus 50 to the second end 56 thereof. Although the support housing may be formed of any conductive material, preferably, the support housing is a titanium housing or any other corrosion-resistant housing. Again, such a titanium housing provides for increased mechanical stability to the pH sensor apparatus 50 and also corrosion resistance.

To seal the electrode element 59 in the titanium housing 68, sealing components 73 are utilized. For example, a heat shrinkable Teflon insulator 78 may be used to encompass the electrode element 59 at the first end 54 of the pH sensor apparatus 50 with a lead 84 terminating and extending from the electrode element 59 to the exterior of the sensor apparatus 50 for connection to, for example, processing and/or signal conditioning devices (e.g., the titanium support housing may be connected to ground such that sensor signals are provided via the lead 84). Further, for example, a metal spacer 76 may be used to hold the electrode element 59 within the support housing 68 along with a Teflon sealant 74 and a ceramic insulator 71.

Yet further, the pH sensor apparatus 50 includes a cooling jacket 70 around the perimeter of the apparatus 50 spaced a radial distance from the axis 52. For example, the cooling jacket may include a number of ceramic insulators positioned using O-rings 75 on the support housing 68. For example, the cooling jacket may be needed to dissipate heat and protect the Teflon sealant from exceeding temperature limitations. Yet further, the support housing 68 is formed with threaded portions 98 for installation of the sensor apparatus 50 at a particular site for a desired application.

One skilled in the art will recognize that any configuration for the conductive support housing and the sealing components may be used without departing from the present invention. Such configurations are generally application dependent and as such will take one of many different forms. The illustrative configuration described herein is but one of many different variations that can be used in conjunction with the present invention.

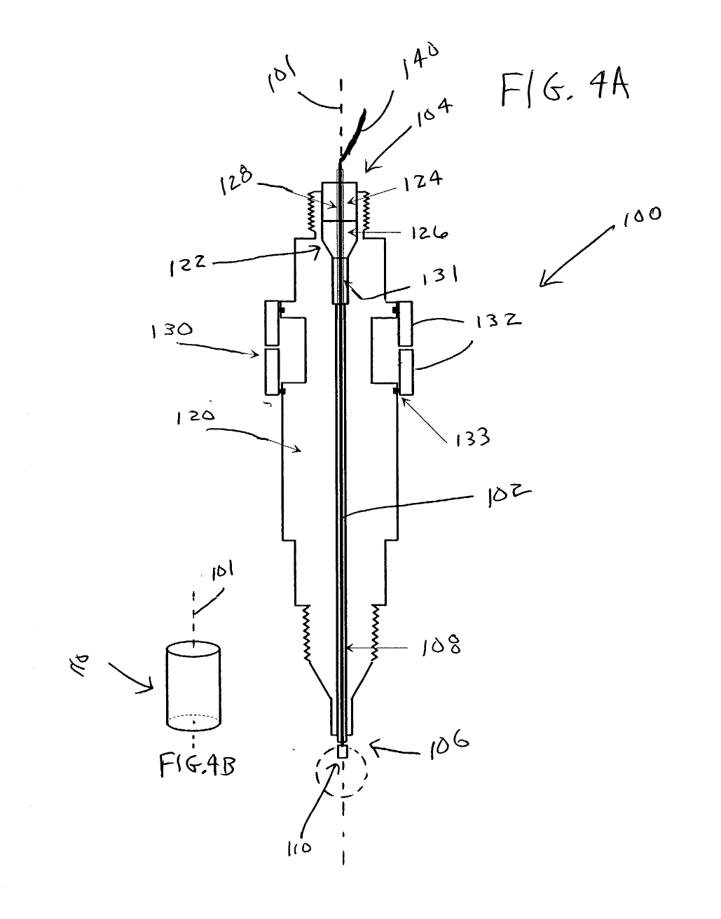

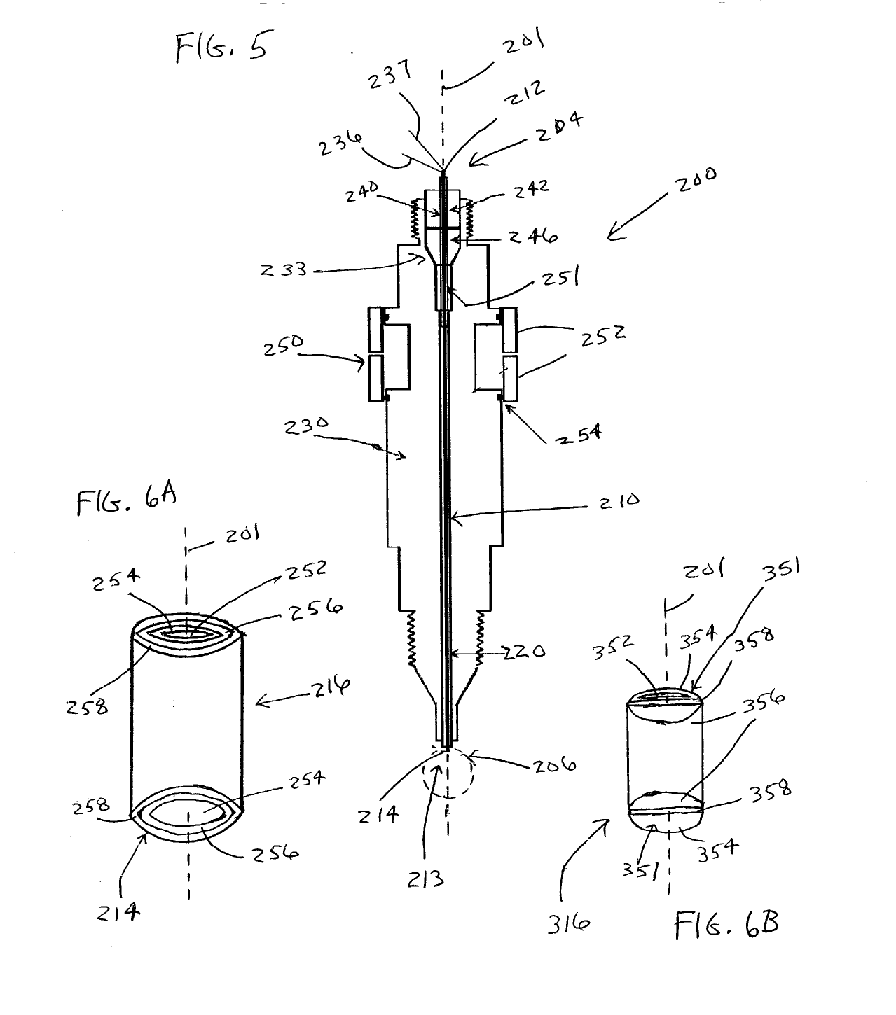

A pH sensor electrode, such as that described with reference to FIGS. 3A-3C, may be used in a dissolved hydrogen concentration (H₂) sensor system 20, e.g., for in situ measurement of dissolved hydrogen (H₂) in aqueous fluids, such as shown in FIG. 2. The hydrogen concentration (H₂) sensor system 20, as shown in FIG. 2, includes a reference electrode 22 such as the pH sensor apparatus 50 described with reference to FIGS. 3A-3C, in combination with a hydrogen sensing element 24, such as a gold electrode as is shown and shall be described with reference to FIGS. 4A-4B. Such hydrogen sensing elements and reference electrodes 22, 23 may be separate electrodes for use in providing signals to processing/analysis circuitry 26 or may be combined into a combination electrode generally represented by dashed line box 24. Several embodiments of such a combination electrode apparatus shall be further described with reference to FIGS. 5 and 6.

Generally, such a hydrogen concentration (H₂) sensor can be described in terms of electrochemical formation as follows:

Au|H₂, H⁺, H₂O|TiO₂|Ti

where Au (gold) serves as a H₂ (hydrogen) sensing element, while Ti/TiO₂ is a pH sensor, which acts as a reference electrode for H₂ measurement.

At a given temperature, pressure, and ionic strength, the measured potential (ΔE in volts) is strictly a function of dissolved H₂, as expressed in the following Nernstain relationship:

$$Δ {E}_{H2} ( V ) = [ {E}_{Ti / TiO2}^{o} + \frac{2.303 R T}{2 F} log ( \frac{{K}_{H} \cdot {γ}_{H2}}{{a}_{H2O}} ) ] + \frac{2.303 R T}{2 F} log ( {m}_{H2} )$$

where R, F, and Tstand for the gas constant, Faraday constant, and temperature (° K), respectively; while a_{H2O} is the activity of water, E_{Ti|TiO2}° is the standard potential for Ti/TiO₂ reference element, and K_{H} (mol kg⁻¹ atm⁻¹) and Y_{H2} are the thermodynamic Henry's law constant and activity coefficient, respectively.

One of the major advantages of the gold and titanium based hydrogen sensor described here is its potential use in aqueous fluids having high concentrations of dissolved H₂S. Unlike platinoid metal-based electrodes, which are often used as hydrogen sensing elements, gold and titanium are completely resistant to dissolved H₂S expanding greatly the range of potential applications. Because two of the most chemically resistant materials can be combined in such a way so as to allow dissolved H₂ measurements to be made over more than an order of magnitude range in concentrations, and at temperatures as high as 450° C., the likelihood that the hydrogen sensor can be used successfully for long-term monitoring applications involving the most chemically and physically challenging environments is enhanced.

One illustrative embodiment of a hydrogen sensing electrode 23 that can be used as a separate electrode with the reference electrode 22 is shown in FIG. 4A by the hydrogen sensing electrode 100. One skilled in the art will note that the general configuration of the hydrogen sensing electrode 100 is very similar to the pH sensor apparatus 50 as shown and described with reference to FIG. 3A. However, the electrode element 102 is preferably a gold wire which, preferably, terminates in a gold foil sensing element 100 as shown in greater detail in FIG. 4B.

In other words, the hydrogen (H₂) sensing electrode 100 extends along axis 101 from a first end 104 to a second end 106. Along the axis 101 lies a gold wire electrode element 102. The gold wire electrode element 102 is coated with a ceramic epoxy coating 108 as an insulating material. The insulating material 108 extends along the gold wire to within a distance from the second end 106.

Preferably, at the second end 106, a gold foil sensing element 110 is positioned for providing a larger sensing surface area. For example, the gold foil sensing element 110 may be a cylindrical element lying along axis 101. However, any element that enlarges the sensing surface area may be used according to the present invention.

Like the pH sensor apparatus 50, as described with reference to FIG. 3A, a titanium housing 120 is provided about the electrode element 102. The electrode element 102 is sealed within the housing 120 by sealing components 122 which include a metal spacer 124, Teflon sealant 126, ceramic element 131, and a heat shrinkable Teflon insulator 128 about the electrode element 102 at the first end 104 of the hydrogen sensing electrode 100. Further, a cooling jacket 130 including ceramic insulating elements 132 is provided about the perimeter of the support housing 120. With such construction, a lead 140 can be provided at the first end 104 of the hydrogen sensing electrode 100 for communication with signal conditioning and/or other processing/analysis circuitry for determining the hydrogen concentration based on potentials measured between the electrode 102 and conductive support housing 120.

As discussed above, the hydrogen sensing electrode and the reference electrode may be provided in a combination electrode configuration as is illustrated in at least two different embodiments shown and which shall be described with reference to FIG. 5 and FIGS. 6A-6B. FIG. 5 shows a cross-sectional view of hydrogen (H₂) sensor apparatus 200 (i.e., a combination hydrogen sensing electrode 23 and reference electrode 22 as shown by the dashed line configuration 24 in FIG. 2).

The hydrogen (H₂) sensor apparatus 200 extends from a first end 204 to a second end 206 along axis 201 of the apparatus 200. Along the axis 201 of the hydrogen sensor apparatus 200 lies an electrode element assembly 210 which extends from a first proximal end 212 of the apparatus 200 (giving way to leads 236 and 237) to a second distal end 214 of the electrode element assembly 210.

The electrode element assembly 210 is provided with an insulating layer 220 on the surface of the electrode element assembly 210 to electrically isolate the electrode element assembly 210 from the conductive support housing 230. Generally, the insulating layer 220 extends from the first end 212 of the electrode assembly 210 to a particular distance from the second end 214 of the electrode element assembly 210, resulting in a sensing head 213 being exposed at the distal end 214 of the electrode element assembly 210.

Concentrically configured about the electrode element assembly 210 coated with the insulating layer 220 is conductive support housing 230. Preferably, the support housing is formed of titanium.

The configuration of the support housing 230 and many of the other elements of the hydrogen (H₂) sensor apparatus 200 are substantially similar to those described with reference to the pH sensor apparatus 50 of FIG. 3A. In other words, the electrode element assembly 210 is sealed within the housing 230 using sealing components 233 including, for example, a metal spacer 242 and a heat shrinkable Teflon insulator 240 encompassing a portion of insulating material 220 on a portion of the electrode assembly 210 at the first end 204 of the hydrogen sensor apparatus 200 along with a Teflon sealant 246 and a ceramic insulator 251. In such a manner, the electrode element assembly 210 is sealed within the housing 230 and leads 236, 237 (i.e., reference electrode and hydrogen (H₂) sensing element leads) can be provided from the electrode element assembly 210 at the first end 204 of the hydrogen sensor apparatus 200. For example, a coupling wire may be soldered to the reference portion of the electrode assembly and a coupling wire may be soldered to the hydrogen sensing electrode portion of the electrode assembly. Once again, the conductive housing 230 may be grounded such that a potential can be read across the reference electrode and housing and also across the hydrogen sensing electrode and the housing.

Further, the support housing 230 may include a cooling jacket 250 about a portion of its perimeter. The cooling jacket 250 may, for example, include a number of ceramic insulators locatable using O-rings 254.

The electrode element assembly 210 may take a variety of different configurations. Two of such configurations are shown and shall be described with reference to FIGS. 6A-6B.

As shown in FIG. 6A, the sensing head 216 which is generally representative of the entire electrode element assembly 210 from the first end 212 to the second end 214 includes a wire core 252 which lies along axis 201 of the hydrogen sensor apparatus 200. The wire core 252 has a discontinuous surface oxide layer 254 formed thereon. The wire core 252 and the surface oxide layer 254 form the reference electrode (e.g., metal/metal oxide pair) of the electrode element assembly 210.

Preferably, the wire core 252 is a titanium wire. Further, preferably, the surface oxide layer 254 is a discontinuous titanium dioxide layer formed in accordance with one of the methods previously described herein.

The reference electrode elements including the titanium core 252 and discontinuous surface oxide layer 254 are provided with an isolation material layer 256 along the surface of the discontinuous surface oxide layer 254. Preferably, the isolation material layer 256 extends along the entire length of the electrode element assembly 210 from first end 212 to second end 214. The isolation layer 256 isolates the reference electrode elements (i.e., the wire core 252 and surface oxide layer 254) from a conductive material layer 258 (e.g., gold) which is formed concentrically about axis 201 on the isolation material layer 256.

In other words, a conductive layer 258, preferably a gold layer, is formed on the isolation material 256 from the first end 212 to the second end 214 of the electrode element assembly 210. The gold layer 258 is then coated with the insulation material 220 to separate the conductive material 258 from the support housing 230.

Preferably, the conductive material layer 258 is formed of gold due to its corrosion resistive characteristics and operational characteristics under high temperatures and high pressure. However, if resistance to sulfide bearing fluids is not required, then other materials such as palladium and platinum may be used.

Preferably, the electrode element assembly 210 includes a titanium wire core 252 having a discontinuous titanium dioxide layer 254 formed on a least a portion thereof at the distal end 214; more preferably formed over substantially the entire wire core with a section removed for connection of lead 237. Further, preferably, the conductive material 258 is gold and is separated by ceramic epoxy material 256 from the titanium dioxide layer 254.

Generally, the titanium wire core and the titanium dioxide layer provide a first conductive portion extending from the first end 212 to the second end 214 of the electrode element assembly 210, while the concentric gold layer at a radial distance from axis 201 forms a second conductive layer extending along the length of the electrode element assembly 210 from first end 212 to second end 214.

As the insulating material 220 is provided on the electrode element assembly 210 only to a certain distance from the second end 214 of the electrode element assembly 210, the exposed sensing head 216 is formed. The sensing head 216 includes, preferably, discontinuous titanium dioxide 254 at the second distal end 214 which allows the underlying titanium core to be partially exposed. Further, exposed gold of the sensing head 216 provides for sensing hydrogen (H₂) concentration.

In other words, the electrode element assembly 210 configured as shown in FIG. 6A includes a reference electrode extending along the axis 201 and a concentric hydrogen sensing electrode extending along the length of the hydrogen sensing apparatus 200 from the first end 204 to the second end 206. The reference electrode is terminated by lead 236 at the first end 204 whereas the hydrogen sensing electrode is terminated by lead 237 at first end 204.

In an alternate embodiment of the electrode element assembly 210, the electrode element assembly 210 is represented by the sensing head 316 shown in FIG. 6B. The sensing head 316 is illustrative of the electrode element assembly 210 as it extends from the first end 204 to the second end 206 of the hydrogen sensing apparatus 200. The electrode element assembly includes a first conductive portion 351 (e.g., in a half moon or half circle configuration) which extends along axis 201 from the first end 212 of the electrode assembly to the second distal end 214 of the electrode assembly to form the reference electrode for the electrode element assembly 210. Likewise, a second conductive portion 356 (e.g., in a half moon or half circle configuration) also extends along axis 201 from the first end 212 to the second end 214 to provide for a hydrogen sensing electrode. The first conductive portion 351 and the second conductive portion 356 are adjacent to one another but separated by an isolation material 358.

The insulating material 220 is provided, preferably, from the first end 212 of electrode element assembly 210 to a position at a particular distance from the second end 214 of the electrode element assembly 210, allowing a portion of the conductive materials to be exposed as the sensing head 316 to perform their desired sensing function.

Preferably, the first conductive portion 351 includes a titanium core portion 352 which extends from the first end 212 to the second end 214 of the electrode element assembly 210. At least the outer surface of the titanium core 352 (i.e., the surface of the sensor head that is exposed for performing the sensing function) has a discontinuous surface titanium dioxide layer 354 formed thereon. For example, the titanium dioxide surface layer may be formed by any of the methods previously described herein. Further, preferably, the second conductive material 356 is formed of gold and also extends from the first end 212 to the second end 214. However, as described above, other conductive materials such as platinum and palladium may be used if reactivity to sulfide bearing fluids is not a concern.

In the various embodiments of the invention described herein, preferably, titanium/titanium dioxide has been used as the pH sensor and/or the material for the reference electrode of the hydrogen (H₂) sensor apparatus. However, the same function and effect may be obtained and is expected from each embodiment when using zirconium as the wire core and a discontinuous zirconium oxide surface layer.

Further, the construction and configuration of the portions and support housings, and also any materials and substances to be used therein, are not limited to those specifically included in the embodiments as shown and described above.

All references cited herein are incorporated in their entirety as if each were incorporated separately. This invention has been described with reference to illustrative embodiments and is not meant to be construed in a limiting sense. Various modifications of the illustrative embodiments, as well as additional embodiments of the invention, will be apparent to persons skilled in the art upon reference to this description.

What is claimed is:

1. A method for use in providing an electrochemical pH sensing apparatus, the method comprising:
providing an electrically conductive electrode element, wherein the conductive electrode element comprises a surface, wherein at least the surface of the conductive electrode element comprises titanium (Ti); and
oxidizing at least a portion of the surface of the conductive electrode element resulting in the formation of a discontinuous titanium oxide (TiOₓ) layer, wherein oxidizing the at least a portion of the surface of the conductive electrode element comprises thermally treating the at least a portion of the surface of the conductive electrode element in the presence of at least one oxygen containing media.

2. The method of claim 1, wherein oxidizing the at least a portion of the surface of the conductive electrode element comprises thermally treating the surface of the conductive electrode element at a temperature in the range of about 300 degrees centigrade to about 880 degrees centigrade.

3. The method of claim 1, wherein oxidizing the at least a portion of the surface of the conductive electrode element comprises thermally treating the surface of the conductive electrode element in the presence of at least one liquid oxygen containing media.

4. The method of claim 3, wherein oxidizing the at least a portion of the surface of the conductive electrode element comprises thermally treating the surface of the conductive electrode element in the presence of at least one liquid alkali element carbonate or peroxide.

5. The method of claim 4, wherein oxidizing the at least a portion of the surface of the conductive electrode element comprises thermally treating the surface of the conductive electrode element in the presence of at least one liquid alkali element carbonate or peroxide selected from the group consisting essentially of Na₂CO₃, Li₂CO₃, and Na₂O₃.

6. The method of claim 1, wherein oxidizing the at least a portion of the surface of the conductive electrode element comprises thermally treating the surface of the conductive electrode element in the presence of at least one oxygen containing media for a time period less than about 2 hours.

7. The method of claim 1, wherein the discontinuous titanium oxide (TiOₓ) layer is formed such that less than 10 percent of the surface of the conductive electrode element is exposed.

8. The method of claim 1, wherein the conductive electrode element comprises a titanium wire, and further wherein oxidizing the at least a portion of the surface of the conductive electrode element comprises oxidizing the titanium wire resulting in the formation of the discontinuous titanium oxide (TiOₓ) layer on a surface of the wire.

9. The method of claim 8, wherein oxidizing the at least a portion of the surface of the conductive electrode element comprises thermally treating a surface of the titanium wire at a temperature in the range of 500 degrees centigrade to 880 degrees centigrade in the presence of at least one oxygen containing media selected from a group consisting essentially of an alkali element carbonate or peroxide for a time period less than 2 hours.

10. The method of claim 8, wherein the method further comprises:
electrically insulating the oxidized titanium wire resulting in an insulated portion of the oxidized titanium wire and a sensing portion at a distal end of the oxidized titanium wire; and
providing a conductive support housing about at least a portion of the insulated portion of the oxidized titanium wire.

11. A method for use in providing an electrochemical pH sensing apparatus, the method comprising:
providing an electrically conductive elongated wire element comprising a surface extending from a first end to a second distal end thereof, wherein at least the surface of the conductive elongated wire element comprises a metal (M);
forming a discontinuous metal oxide (MₓO_{y}) layer on at least a portion of the surface proximate the second distal end of the conductive elongated wire element;
providing an insulating layer on at least a portion of the conductive elongated wire element resulting in an insulated portion of the conductive elongated wire element and a sensing portion at the second distal end of the conductive elongated wire element, wherein the sensing portion comprises exposed metal through the discontinuous metal oxide layer; and
providing a conductive support housing about at least a portion of the insulated portion.

12. The method of claim 11, wherein forming a discontinuous metal oxide (MₓO_{y}) layer on at least a portion of the surface of the conductive elongated wire element comprises electrochemical plating the surface of the conductive elongated wire element with the metal oxide.

13. The method of claim 11, wherein forming a discontinuous metal oxide (MₓO_{y}) layer on at least a portion of the surface of the conductive elongated wire element comprises thermally treating the surface of the conductive elongated wire element in the presence of at least one oxygen containing media.

14. The method of claim 13, wherein thermally treating the surface of the conductive elongated wire element in the presence of at least one oxygen containing media comprises thermally treating the surface of the conductive elongated wire element at a temperature in the range of about 300 degrees centigrade to about 880 degrees centigrade.

15. The method of claim 13, wherein thermally treating the surface of the conductive elongated wire element in the presence of at least one oxygen containing media comprises thermally treating the surface of the conductive elongated wire element in the presence of at least one liquid alkali element carbonate or peroxide.

16. The method of claim 15, wherein thermally treating the surface of the conductive elongated wire element in the presence of at least one oxygen containing media comprises thermally treating the surface of the conductive elongated wire element in the presence of at least one liquid alkali element carbonate or peroxide selected from the group consisting essentially of Na₂CO₃, Li₂CO₃, and Na₂O₃.

17. The method of claim 13, thermally treating the surface of the conductive elongated wire element in the presence of at least one oxygen containing media comprises thermally treating the surface of the conductive support element in the presence of at least one oxygen containing media for a time period less than 2 hours.

18. The method of claim 11, wherein forming a discontinuous metal oxide layer on at least a portion of the surface of the conductive elongated wire element comprises forming a discontinuous metal oxide layer such that less than 10 percent of the surface of the conductive elongated wire element is exposed.

19. The method of claim 11, wherein the surface of the conductive elongated wire element comprises at least one of titanium and zirconium.

20. The method of claim 19, wherein the surface of the conductive elongated wire element comprises titanium and the discontinuous metal oxide layer comprises titanium dioxide.

21. The method of claim 11, wherein the conductive elongated wire element comprises a titanium wire.

22. A method for use in providing an electrochemical hydrogen (H₂) sensing apparatus, the method comprising:
providing an electrically conductive elongated wire element comprising a surface extending from a first end to a second end thereof, wherein at least the surface of the conductive elongated wire element comprises a metal (M);
forming a discontinuous metal oxide (MₓO_{y}) layer on at least a portion of the surface proximate the second end of the conductive elongated wire element, wherein at least a portion of the electrically conductive elongated wire element proximate the second end having the discontinuous metal oxide layer formed thereon is used to provide a reference sensing portion;
providing a conductive layer adjacent to the conductive elongated wire element from the first end to the second end thereof but isolated from the conductive elongate wire element by a first insulating layer, wherein the conductive layer comprises a conductive material proximate at least the second end to provide a hydrogen sensing portion;
providing a second insulating layer over at least the conductive layer such that the reference sensing portion and the hydrogen sensing portion at the second end are exposed; and
providing a conductive support housing about at least a portion of the second insulating layer.

23. The method of claim 22, wherein the conductive material comprises gold.

24. The method of claim 22, wherein the metal (M) comprises titanium.

25. The method of claim 22, wherein forming a discontinuous metal oxide (MₓO_{y}) layer on at least a portion of the surface of the conductive elongated wire element comprises electrochemical plating the surface of the conductive elongated wire element.

26. The method of claim 22, wherein forming a discontinuous metal oxide (MₓO_{y}) layer on at least a portion of the surface of the conductive elongated wire element comprises thermally treating the surface of the conductive elongated wire element in the presence of at least one oxygen containing media.

27. The method of claim 26, wherein thermally treating the surface of the conductive elongated wire element in the presence of at least one oxygen containing media comprises thermally treating the surface of the conductive elongated wire element at a temperature in the range of 300 degrees centigrade to 880 degrees centigrade.

28. The method of claim 26, wherein thermally treating the surface of the conductive elongated wire element in the presence of at least one oxygen containing media comprises thermally treating the surface of the conductive elongated wire element in the presence of at least one liquid oxygen containing media.

29. The method of claim 28, wherein thermally treating the surface of the conductive elongated wire element in the presence of at least one oxygen containing media comprises thermally treating the surface of the conductive elongated wire element in the presence of at least one liquid alkali element carbonate or peroxide.

30. The method of claim 26, wherein thermally treating the surface of the conductive elongated wire element in the presence of at least one oxygen containing media comprises thermally treating the surface of the conductive elongated wire element in the presence of at least one oxygen containing media for a time period less than 2 hours.

31. The method of claim 22, wherein forming a discontinuous metal oxide layer on at least a portion of the surface of the conductive elongated wire element comprises forming a discontinuous metal oxide layer such that less than 10 percent of the surface of the conductive elongated wire element is exposed.

32. The method of claim 22, wherein the conductive elongated wire element comprises a titanium wire.

33. The method of claim 22, wherein the conductive material comprises gold, and further wherein the metal (M) comprises titanium.

34. A method of providing an electrochemical hydrogen (H₂) sensing apparatus, the method comprising:
providing an elongated electrode assembly, wherein providing the elongated electrode assembly comprises:
providing a first conductive portion extending from a first end of the elongated electrode assembly to a second end of the elongated electrode assembly, wherein the first conductive portion comprises a metal core having a discontinuous metal oxide layer formed on at least a portion of a surface of the metal core;
providing a second conductive portion extending from the first end of the elongated electrode assembly to the second end of the elongated electrode assembly, wherein the second conductive portion comprises a conductive material for use in sensing hydrogen (H₂); and
providing an isolation material extending from the first end of the elongated electrode assembly to the second end of the elongated electrode assembly electrically isolating the first conductive portion from the second conductive portion; and
providing an insulating material over the elongated electrode assembly resulting in an exposed sensing portion at the second end of the elongated electrode assembly, wherein the exposed sensing portion comprises exposed metal through the discontinuous metal oxide layer of the first conductive portion and exposed conductive material of the second conductive portion; and
providing a conductive support housing about at least a portion of the insulating material.

35. The method of claim 34, wherein the conductive material comprises gold.

36. The method of claim 34, wherein the metal core comprises titanium.

37. The method of claim 34, wherein the method further comprises forming the discontinuous metal oxide layer on at least the portion of the surface of the metal core by electrochemical plating the surface of at least a portion of the metal core.

38. The method of claim 34, wherein the method further comprises forming the discontinuous metal oxide layer on at least the portion of the surface of the metal core by thermally treating the surface of the metal core in the presence of at least one oxygen containing media.

39. The method of claim 34, wherein thermally treating the surface of the metal core in the presence of at least one oxygen containing media comprises thermally treating the surface of the metal core in the presence of at least one liquid oxygen containing media.

40. The method of claim 39, wherein thermally treating the surface of the metal core in the presence of at least one oxygen containing media comprises thermally treating the surface of the metal core in the presence of at least one liquid alkali element carbonate or peroxide.

41. The method of claim 34, wherein providing the first conductive portion comprises providing a wire extending along an axis therethrough and a concentric discontinuous metal oxide layer formed on a radial surface of the wire along the axis; and further wherein providing the second conductive portion comprises providing a concentric layer of conductive material formed radially relative to the axis and separated from the discontinuous metal oxide layer by the isolation material.

42. The method of claim 34, wherein providing the first conductive portion comprises providing a metal core of material from the first end of the elongated electrode assembly to the second end of the elongated electrode assembly with the discontinuous metal oxide layer formed on at least a portion of the surface of the metal core, and further wherein providing the second conductive portion comprises providing a conductive material from the first end of the elongated electrode assembly to the second end of the elongated electrode assembly adjacent to but separated from the metal core and the discontinuous metal oxide layer formed thereon by at least the isolation material.

43. The method of claim 34, wherein the metal core comprises titanium and the conductive material comprises gold.

44. An electrochemical pH sensing apparatus comprising:
an electrically conductive wire core extending between a first end and a second end along an axis, wherein at least a surface of the wire core comprises titanium (Ti);
a discontinuous titanium oxide (TiOₓ) layer on at least a portion of the surface of the wire core;
an insulating layer formed relative to the discontinuous titanium oxide layer formed on at least a portion of the wire core so as to provide a sensing portion at the second end of the wire core, wherein the sensing portion comprises exposed titanium through openings in the discontinuous titanium oxide layer; and
a conductive support housing electrically isolated from at least the wire core by the insulating layer.

45. The apparatus of claim 44, wherein the exposed titanium through the discontinuous titanium oxide layer is less than 10 percent.

46. The apparatus of claim 44, wherein the discontinuous titanium oxide layer comprises titanium dioxide.

47. The apparatus of claim 44, wherein the conductive support housing comprises titanium.

48. An electrochemical pH sensing apparatus comprising:
an electrically conductive elongated wire core extending between a first end and a second end along an axis thereof, wherein at least a surface of the wire core comprises a metal (M);
a discontinuous metal oxide (MₓO_{y}) layer provided on at least a portion of the surface proximate the second end of the wire core;
an insulating layer provided on at least a portion of the discontinuous metal oxide layer resulting in an insulated portion of the wire core and also a sensing portion at the second end of the wire core, wherein the sensing portion comprises exposed metal through openings in the discontinuous metal oxide layer; and
a conductive support housing about at least a portion of the insulated portion.

49. The apparatus of claim 48, wherein the exposed metal through the discontinuous metal oxide layer is less than 10 percent.

50. The apparatus of claim 48, wherein at least the surface of the wire core comprises at least one of titanium and zirconium.

51. The apparatus of claim 50, wherein the surface of the wire core comprises titanium and the discontinuous metal oxide layer comprises titanium dioxide.

52. The apparatus of claim 48, wherein the discontinuous metal oxide layer, where present, has a thickness of less than 3 micrometers.

53. An electrochemical hydrogen (H₂) sensing apparatus comprising:
an electrically conductive elongated wire core element extending between a first and second end of the apparatus along an axis thereof, wherein at least a surface of the wire core element comprises a metal (M);
a discontinuous metal oxide (MₓO_{y}) layer formed on at least a portion of the surface of the wire core element proximate the second end;
a conductive layer extending along the axis, wherein the conductive layer comprises a conductive material for use in sensing hydrogen;
a first insulating layer located to electrically isolate the conductive layer from the conductive elongated wire core element;
a second insulating layer formed over at least a portion of the conductive layer resulting in a sensing portion at the second end of the apparatus, wherein the sensing portion comprises at least a portion of the conductive wire core element having the discontinuous metal oxide layer formed thereon and exposed conductive material; and
a conductive support housing about at least a portion of the second insulating layer.

54. The apparatus of claim 53, wherein the conductive material comprises gold.

55. The apparatus of claim 53, wherein the metal (M) comprises titanium.

56. The apparatus of claim 55, wherein the discontinuous metal oxide layer comprises titanium dioxide.

57. The apparatus of claim 53, wherein the discontinuous metal oxide layer comprises a discontinuous metal oxide layer formed such that less than 10 percent of the surface of the wire core element is exposed through openings in the discontinuous metal oxide layer.

58. An electrochemical hydrogen (H₂) sensing apparatus comprising:
an elongated electrode assembly, wherein the elongated electrode assembly comprises:
a first conductive portion extending from a first end of the elongated electrode assembly to a second end of the elongated electrode assembly, wherein the first conductive portion comprises a metal core with a discontinuous metal oxide layer formed on at least a portion of a surface of the metal core;
a second conductive portion extending from the first end of the elongated electrode assembly to the second end of the elongated electrode assembly, wherein the second conductive portion comprises a conductive material for use in sensing hydrogen; and
an isolation material extending from the first end of the elongated electrode assembly to the second end of the elongated electrode assembly electrically isolating the first conductive portion from the second conductive portion; and
an insulating material formed over the elongated electrode assembly resulting in a sensing portion at the first end of the elongated electrode assembly, wherein the sensing portion comprises exposed metal through openings in the discontinuous metal oxide layer of the first conductive portion and exposed conductive material of the second conductive portion; and
a conductive support housing provided about at least a portion of the insulating material.

59. The apparatus of claim 58, wherein the conductive material comprises gold.

60. The apparatus of claim 58, wherein the metal core comprises titanium.

61. The apparatus of claim 58, wherein the discontinuous metal oxide layer comprises a discontinuous metal oxide layer formed such that less than 10 percent of the surface of the wire core element is exposed through the openings in the discontinuous metal oxide.

62. The apparatus of claim 58, wherein the first conductive portion comprises a wire extending along an axis of the elongated electrode assembly and a concentric discontinuous metal oxide layer formed on a radial surface of the wire along the axis; and further wherein the second conductive portion comprises a concentric layer of conductive material formed radially relative to the axis and separated from the discontinuous metal oxide layer by the isolation material.

63. The apparatus of claim 58, wherein the metal core comprises titanium and the conductive material comprises gold.

64. The apparatus of claim 58, wherein the first conductive portion is provided adjacent to but separated from the second conductive portion by at least the isolation material.

65. An electrochemical pH sensing electrode apparatus, the apparatus comprising:
an electrically conductive electrode element, wherein the conductive electrode element comprises a surface, wherein at least the surface of the conductive electrode element comprises one of titanium (Ti) and zirconium (Zr); and
a discontinuous oxide layer on at least a portion of the surface of the conductive electrode element, wherein the discontinuous oxide layer comprises one of titanium oxide (TiOₓ) and zirconium oxide (ZrOₓ), and further wherein openings in the discontinuous oxide layer allow for sensing of hydrogen ions at the surface of the conductive electrode element for use in determining pH of a composition when immersed therein.

66. The apparatus of claim 65, wherein less than 10 percent of the surface of the conductive electrode element is exposed through the openings in the discontinuous oxide layer.

67. The apparatus of claim 65, wherein the conductive electrode element comprises titanium and the discontinuous oxide layer comprises titanium dioxide.

68. The apparatus of claim 65, wherein the apparatus further comprises:
an insulating layer provided on at least a portion of the discontinuous oxide layer resulting in an insulated portion of the conductive electrode element and also a sensing portion, wherein the sensing portion comprises exposed titanium (Ti) or zirconium (Zr) through the openings in the discontinuous oxide layer; and
a conductive support housing about at least a portion of the insulated portion.
